(19) United States
(12) Patent Application Publication
(10) Pub. No.: US 2016/0363852 A1
(43) Pub. Date: Dec. 15, 2016

(54) SINGLE AXIS STEREOSCOPIC IMAGING APPARATUS WITH DUAL SAMPLING LENSES

(71) Applicants: Ichiro Shinkoda, Vancouver (CA); Thomas N. Mitchell, Bowen Island (CA)

(72) Inventors: Ichiro Shinkoda, Vancouver (CA); Thomas N. Mitchell, Bowen Island (CA)

(21) Appl. No.: 14/343,914

(22) PCT Filed: Sep. 10, 2012
(86) PCT No.: PCT/IB2012/002557

§ 371 Date: May 20, 2016

Related U.S. Application Data
(60) Provisional application No. 61/532,984, filed on Sep. 9, 2011.
(60) Provisional application No. 61/586,738, filed on Jan. 13, 2012.

(51) Int. Cl. G03B 35/10; H04N 13/02; G02B 15/14; G03B 9/02; G03B 5/00

(52) U.S. Cl. CPC G03B 35/10; G03B 9/02; G03B 5/00; G02B 15/14; H04N 13/0217

(57) ABSTRACT

A stereoscopic imager comprises a lens having a front lens assembly, a rear lens assembly, and two sampling lenses. The sampling lenses are disposed on opposite sides of the optical axis of the lens, between the front and rear lens assemblies, and proximate an aperture plane of the lens. The stereoscopic imager can comprise a first aperture and a second aperture, which apertures can be variable apertures. The first and second apertures are disposed within the aperture plane of the lens and substantially in line with the first and second sampling lenses. The sampling lenses can be abaxial with the apertures. The lens can form a double Gauss lens for suppressing optical aberration and coupling to a small imaging sensor. The two sampling lenses allow the imager to form on the sensor two images with differing perspectives of an object in the field of view of the lens.

### CROSS-REFERENCE TO RELATED APPLICATION

This invention can be combined with the subject matter of our provisional application No. 61/586,736 entitled SINGLE OPTICAL PATH ANAMORPHIC STEREOSCOPIC IMAGER filed on Jan. 13, 2012 and herein incorporated by reference.

### FIELD OF THE INVENTION

This invention relates, in general, to stereoscopic imaging. More specifically, this invention relates to a single lens arrangement for sampling different portions of a single optical path in a stereoscopic imaging apparatus using dual sampling lenses.

### BACKGROUND OF THE INVENTION

The phenomenon of stereoscopic vision, or stereopsis, is directly associated with the ability of humans and animals with binocular vision to perceive depth in a scene. It is the perceptual effect produced by the human brain simultaneously processing two sets of slightly differing two-dimensional optical data. The phenomenon, as experienced by an unaided human observer, is based on the fact that the retinal images formed by the two eyes of the observer differ slightly. A point object in a scene observed by the human observer is imaged in a slightly different position in the left retinal image as compared with the image of the same scene on the right retina.

Initially stereoscopic imagery was created using images taken by two separate cameras. Work, particularly in the video-imaging field, has led to systems in which two complete imaging systems are incorporated permanently into single stereoscopic viewers. Such viewers typically have dual optical axes and twin objective optical subsystems providing two optical paths. They typically have one optical axis for the right eye view and one for the left eye view to produce two complete images, one for the right eye perspective and one for the left eye perspective, side by side on two imaging sensors.

Some implementations of stereoscopic imaging systems have a single optical path around a central optical axis. In order to obtain a stereoscopic image pair, such systems sample different portions of the light in the single imaging path, representing two different perspectives of the field of view of the lens of the imaging system. Various means may be employed to sample the two portions of the light in the single image path.

Some implementations, by way of example, employ mutually orthogonal linear polarizers to sample two substantially mutually exclusive portions of the light in the single image path. The light is then alternately directed to a suitable imaging sensor based on the polarization state. Some implementations employ imaging sensors that can differentiate between two polarization states whilst simultaneously recording them. Yet other implementations direct the light from the two portions of the single imaging path to different imaging sensors.

One of the enduring challenges of single imaging path stereoscopic systems is that of ensuring good optical imaging performance for the two separately formed images from the two portions of the single imaging path even as the sizes of this kind of equipment shrinks. In this respect, those systems in which the two images are differentiated on the basis of polarization state of the light suffer from an inherent disadvantage in that a major fraction of the useful light is intentionally rejected in the polarization process. An improved system would therefore avoid the use of polarization of light to separate the two images and would couple efficiently with small imaging sensors.

### SUMMARY OF THE INVENTION

In accordance with a first aspect of the invention a stereoscopic imager comprises a lens having a front lens assembly disposed along an optical axis; a rear lens assembly disposed along the optical axis; and first and second sampling lenses disposed on opposite sides of the optical axis between the front lens assembly and the rear lens assembly, and proximate an aperture plane of the lens. The stereoscopic imager can further comprise a first aperture and a second aperture, the first aperture and the second aperture being disposed within the aperture plane of the lens and substantially in line with respectively the first sampling lens and the second sampling lens. The first and second apertures are separated by an inter-aperture distance and the first and second apertures can be configured to allow changing the stereopsis of the imager by changing the inter-aperture distance. The lens can be configured to allow the first and second sampling lens to move in cooperation with respectively the first and second aperture. The first and second apertures can be variable apertures.

The first sampling lens can comprise a first front component sampling lens and a first rear component sampling lens, the first front component sampling lens being disposed between the first aperture and the front lens assembly and proximate the first aperture, the first rear component sampling lens disposed between the first aperture and the rear lens assembly and proximate the first aperture. The second sampling lens can comprise a second front component sampling lens and a second rear component sampling lens, the second front component sampling lens disposed between the second aperture and the front lens assembly and proximate the second aperture, the second rear component sampling lens disposed between the second aperture and the rear lens assembly and proximate the second aperture.

The stereoscopic imager further comprises an imaging sensor disposed along the optical axis behind the rear lens assembly. The imaging sensor is operable to receive a first image and a second image from the lens, wherein the first image is formed from light sampled by the first sampling lens from a first portion of light from a field of view of the lens and the second image is formed from light sampled by the second sampling lens from a second portion of light from the field of view of the lens. The stereoscopic imager further comprises a controller for extracting image data for the first image and the second image from the imaging sensor, the first image data representing a first perspective of an object in the field of view of the lens and the second image data representing a second perspective of the object. The imaging sensor can comprise a first component imaging sensor disposed to receive the first image and a second component imaging sensor disposed to receive the second image.

The focal length of at least one of the first sampling lens and the second sampling lens can be less than half the focal length of the combination of the front lens assembly and the rear lens assembly in the absence of the first and second sampling lenses. The focal length of the combination of the front lens assembly, the rear lens assembly and one of the first and second sampling lenses can be less than the focal length of the combination of the front lens assembly and the rear lens assembly in the absence of the first and second sampling lenses. The front lens assembly and rear lens assembly together can form a double Gauss lens. In other embodiments the front lens assembly and rear lens assembly together are a zoom lens. In other embodiments of the invention yet further lens combinations are possible for the front lens assembly and rear lens assembly. The lens can be configured in its zoom operation to allow the first and second sampling lens to move in cooperation with respectively the first and second aperture.

In a further embodiment of the invention a stereoscopic imager comprises first and second sampling lenses disposed on opposite sides of an optical axis; an imaging sensor disposed along the optical axis behind the sampling lenses; and a rear lens assembly disposed along the optical axis between the sampling lenses and the imaging sensor and configured to form on the imaging sensor a first image from light collected by the first sampling lens and a second image from light collected by the second sampling lens. The stereoscopic imager can further comprise a front lens assembly disposed along the optical axis in front of the first and second sampling lenses, the front lens assembly having a field of view, and the front lens assembly configured to provide from a first portion of the field of view the light collected by the first sampling lens and to provide from a second portion of the field of view the light collected by the second sampling lens.

The stereoscopic imager can comprise a first aperture and a second aperture, the first aperture disposed between the front lens assembly and the rear lens assembly and substantially in line with the first sampling lens and the second aperture disposed between the front lens assembly and the rear lens assembly and substantially in line with the second sampling lens. The first aperture and second apertures can be variable apertures.

The first sampling lens can comprise a first front component sampling lens and a first rear component sampling lens, the first front component sampling lens disposed between the first aperture and the front lens assembly and proximate the first aperture, the first rear component sampling lens disposed between the first aperture and the rear lens assembly and proximate the first aperture. The second sampling lens can comprise a second front component sampling lens and a second rear component sampling lens, the second front component sampling lens disposed between the second aperture and the front lens assembly and proximate the second aperture, the second rear component sampling lens disposed between the second aperture and the rear lens assembly and proximate the second aperture.

The stereoscopic imager further comprises a controller for extracting image data for the first image and the second image from the imaging sensor, the first image data representing a first perspective of an object in the field of view of the front lens assembly and the second image data representing a second perspective of the object. The focal length of at least one of the first sampling lens and the second sampling lens can be less than half the focal length of the combination of the front lens assembly and the rear lens assembly in the absence of the first and second sampling lenses. The focal length of the combination of the front lens assembly, the rear lens assembly and one of the first and second sampling lenses can be less than the focal length of the combination of the front lens assembly and the rear lens assembly in the absence of the first and second sampling lenses. The front lens assembly and rear lens assembly together can form a double Gauss lens. The imaging sensor can comprise a first component imaging sensor disposed to receive the first image and a second component imaging sensor disposed to receive the second image.

In another embodiment the first and second sampling lenses can be disposed proximate, overlapping and abaxial with respectively the first and second apertures, and can be configured to move in cooperation with the apertures and also to be moved relative to the apertures. This allows freedom in the choice of where on the sensor to form the first and second images.

In accordance with a second aspect of the invention a method for forming on an imaging sensor a stereoscopic image pair, the image pair comprising a first image and a second image providing two different perspectives of an object within a field of view of a first lens disposed along an optical axis, comprises gathering light from the object through the first lens; directing the gathered light along a single optical path generally about the optical axis to a first sampling lens disposed on a first side of the optical axis and to a second sampling lens disposed on an opposite side of the optical axis from the first sampling lens; sampling through the first sampling lens light from a first portion of the single optical path; simultaneously sampling through the second sampling lens light from a second portion of the single optical path; and forming on an imaging sensor disposed along the optical axis first and second images from respectively the light sampled from the first portion of the single imaging path and the light sampled from the second portion of the imaging path. The forming the first image can be by processing the light sampled from the first portion of the single optical path through a cylindrically symmetric second lens disposed on the optical axis; and the forming the second image can be by processing the light sampled from the second portion of the single optical path through the second lens. The directing the gathered light to the first and second sampling lenses can comprise directing the light through respectively first and second apertures, wherein the first and second sampling lenses are disposed proximate, overlapping and abaxial with the respective first and second apertures.

The method can further comprise at least one of adjusting a depth of focus of the first image by changing the size of a first aperture disposed proximate the first sampling lens; and adjusting a depth of focus of the second image by changing the size of a second aperture disposed proximate the second sampling lens. The imaging sensor can comprise a first and a second component imaging sensor and the method can comprise forming the first and second images on the first and second component imaging sensors respectively.

### BRIEF DESCRIPTION OF THE DRAWINGS

Aspects of the present invention are particularly pointed out and distinctly claimed as examples in the claims at the conclusion of the specification. The foregoing and other objects, features, and advantages of the invention are apparent from the following detailed description taken in conjunction with the accompanying drawing in which:

FIG.1 shows a single axis stereoscopic imager

FIG.2 shows a second view of the stereoscopic imager of FIG.1

FIG.3 shows another embodiment of a single axis stereoscopic imager

FIG.4 shows a second view of the stereoscopic imager of FIG.3

FIG.5 shows a flow diagram of a method for forming stereoscopic image pair

### DETAILED DESCRIPTION OF AN ILLUSTRATIVE EMBODIMENT

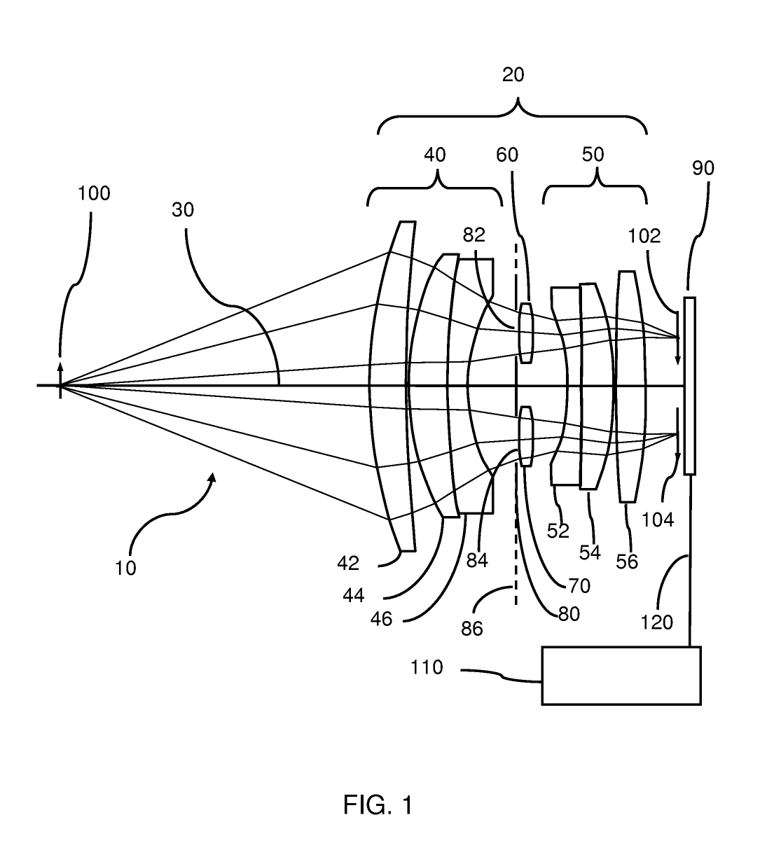

In accordance with a first aspect of the present invention there is provided a single optical axis stereoscopic imaging apparatus for simultaneously obtaining a pair of stereoscopic images of a scene on an imaging sensor. According to a first embodiment of the invention, shown schematically in plan view and generally at 10 in FIG. 1, the apparatus comprises a lens 20 generally oriented with its axis along an optical axis 30 and an imaging sensor 90 arranged to receive images from the lens 20. The lens 20 comprises front lens assembly 40 and rear lens assembly 50. The front lens assembly 40 is operable to direct light captured within a field of view of the lens 20 to an aperture plane 86 of the lens 20. The aperture plane 86 may be a physical aperture plane of the lens 20 or may be a conjugate of the aperture plane. An aperture plate 80 can be disposed at the aperture plane 86. The aperture plate 80 can comprise a first aperture 82 and a second aperture 84 disposed either side of the optical axis 30 and separated in a horizontal plane by an inter-aperture distance. The term “inter-aperture distance” is used in the present specification to describe the center-to-center distance between the two apertures 82 and 84. Apertures 82 and 84 can be fixed apertures. The first and second apertures 82 and 84 can be configured to allow changing the stereopsis of the imager by changing the inter-aperture distance.

In some embodiments of the invention apertures 82 and 84 can be variable apertures to provide the facility of varying the depth of focus of lens 20. Front lens assembly 40 comprises, by way of example, lenses 42, 44 and 46, and can be, but is not limited to, a Gauss lens with a positive meniscus lens on the object side and a negative meniscus lens on the image side. Rear lens assembly 50 comprises, by way of example, lenses 52, 54 and 56, and can be, but is not limited to, a Gauss lens, oriented back-to-back with respect to front lens assembly 40.

The lens 20 comprises a first sampling lens 60 disposed substantially in line with and proximate the first aperture 82 in order to operate on light captured with a first perspective from within the field of view of the lens 20 by the front lens assembly 40. The lens 20 comprises a second sampling lens 70 disposed substantially in line with and proximate the second aperture 84 in order to operate on light captured with a second perspective from within the field of view of the lens 20 by the front lens assembly 40. The first sampling lens 60 therefore samples light from a first portion of an optical path generally about the optical axis 30, while the second sampling lens 70 samples light from a second portion of the optical path. Light from the first sampling lens 60 is imaged onto the imaging sensor 90 by the rear lens assembly 50 to create a first image 102 having a first perspective of an object 100 disposed along the optical axis 30. Light from the second sampling lens 70 is imaged onto the imaging sensor 90 by the rear lens assembly 50 to create a second image 104 having a second perspective of the object 100 disposed along the optical axis 30.

The focal lengths of the first sampling lens 60 and the second sampling lens 70 can be less than half the focal length of the combination of the front lens assembly 40 and the rear lens assembly 50 in the absence of the first sampling lens 60 and the second sampling lens 70. With this choice of focal lengths, the focal length of the combination of the front lens assembly 40, the rear lens assembly 50 and one of the first sampling lens 60 and second sampling lens 70 can be less than the focal length of the combination of the front lens assembly 40 and the rear lens assembly 50 in the absence of the first sampling lens 60 and the second sampling lens 70. Sampling lenses 60 and 70 can each have a positive power.

By way of example, lens 20 without the sampling lenses 60 and 70 can have a focal length of 126 mm. Sampling lenses 60 and 70 can each have a focal length of 44 mm. Based on these choices, the combined lens 20 will have a resulting focal length of 60 mm.

The arrangement allows a 60 mm lens to employ a larger inter-aperture distance that is appropriate to a much larger 126 mm lens with an associated larger entrance pupil. The consequence is a much larger stereopsis to be attainable with the 60 mm lens arrangement than what might be expected from a typical 60 mm lens with its wider angle and its naturally larger field of view. It combines the benefits of the 126 mm lens with those of a 60 mm lens as regards three-dimensional imaging applications.

FIG. 1 is schematic in nature and not to scale. The distance between lens 42 and the object 100 is typically much longer than that shown in FIG. 1. Light rays from the object 100 therefore follow refracting paths through the various lenses are different from those shown in FIG. 1 and the light rays shown in FIG. 1 are provided here purely for the sake of understanding the general working of lens 20 and its constituent lenses. In particular, the paths of light rays through sampling lenses 60 and 70 are purely schematic, the refraction of the light through the two lenses being considerably different from that shown herein.

To the extent that the first image 102 and the second image 104 represent different perspectives of the object 100, they may be employed to derive three-dimensional (3D) information about the object 100. More particularly, a controller 110 may extract image data representing the two images 102 and 104 from imaging sensor 90 via image data output connection 120 and may be configured to process the images digitally, thereby to supply them in appropriate format to a three-dimensional display or viewing system (not shown). Imaging sensor 90 can be a single array imaging sensor, including but not limited to a Charge Coupled Device (CCD).

The degree of stereopsis achievable with a three-dimensional imager is fundamentally dependent on the angular difference between the two perspectives used to create the images used to render the three-dimensional view. In the description herein the specific use of sampling lenses 60 and 70 provides the benefit of a large perspective difference as result of the use of the front lens assembly 40 that is large in comparison with the sampling lenses 60 and 70, whilst still producing an overall lens system, given by lens 20, that has a short focal length. This allows the lens 20 to be employed with small low cost imaging sensors. The inter-aperture distance between apertures 82 and 84 is greater than that achievable in three-dimensional imagers employing such small imaging sensors in conjunction with prior art imaging lens arrangements. The result is greater stereopsis than that achievable with prior art lenses applied to comparable imaging sensors.

In one embodiment of the invention first sampling lens 60 is configured to move in cooperation with first aperture 82 and second sampling lens 70 is configured to move in cooperation with second aperture 84 when first aperture 82 and second aperture 84 are moved in the process of changing the inter-aperture distance.

In one embodiment of the invention imaging sensor 90 can comprise a separate first component imaging sensor disposed to receive the first image 102 and a separate second component imaging sensor disposed to receive the second image 104.

In one embodiment of the invention the combined structure of front lens assembly 40 and rear lens assembly 50 form a double-Gauss lens. Double-Gauss optical designs are known in the art for their superlative performance in respect of keeping optical aberration in the system very low. The use of double Gauss lenses is well established in the field of wide-aperture lenses on standard 35 mm cameras. The light from a first portion of an optical path through a double Gauss lens is sampled using a first sampling lens 60 disposed proximate the aperture plane 86 and light from a second portion of an optical path through the double Gauss lens is sampled using a second sampling lens 70 disposed proximate the aperture plane 86. The light sampled by first sampling lens 60 is used to form the first image 102 on imaging sensor 90 and the light sampled by second sampling lens 70 is used to form the second image 102 on imaging sensor 90. The images have low aberration due to the use of the double Gauss design.

In one embodiment of the present invention the combined structure of front lens assembly 40 and rear lens assembly 50 can allow the lens 20 to be a zoom lens for changing the sizes of images 102 and 104 on imaging sensor 90. In other embodiments of the invention yet further lens combinations are possible for the front lens assembly and rear lens assembly.

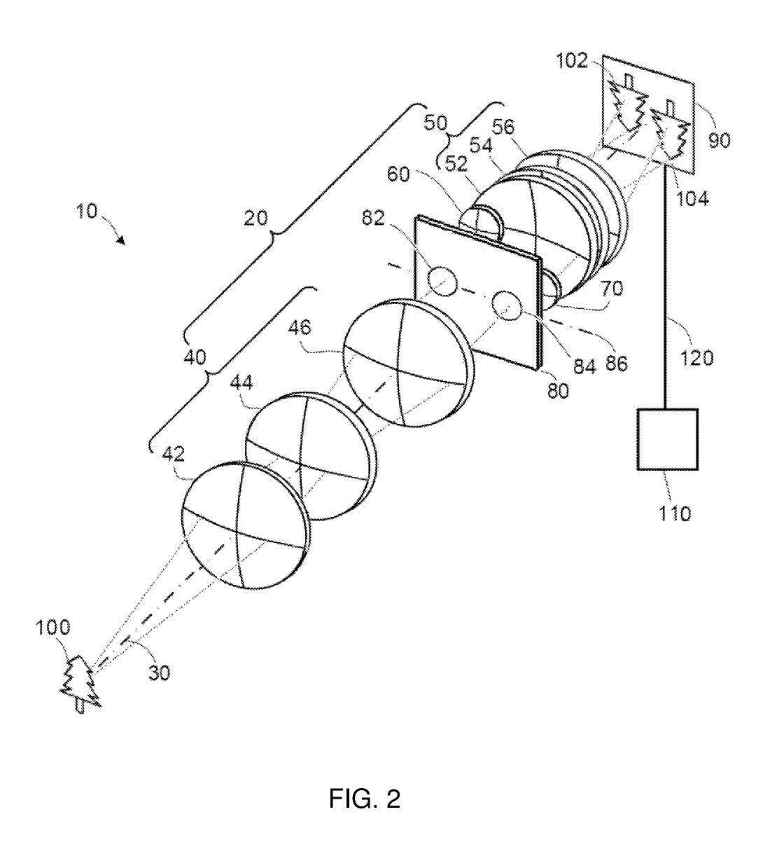

In a further embodiment, the sampling lenses can be located abaxial with the apertures. We describe this embodiment at the hand of FIG. 2, which shows another view of apparatus 10 of FIG. 1. The apparatus is shown in partially exploded form for the sake of clarity. In this embodiment the lens 20 comprises the first sampling lens 60 disposed proximate, overlapping and abaxial with the first aperture 82. The lens 20 further comprises the second sampling lens 70 disposed proximate, overlapping and abaxial with the second aperture 84. By moving the sampling lenses 60 and 70 abaxially with their respective corresponding apertures 82 and 84, images 102 and 104 can be positioned with freedom on imaging sensor 90. This can include placing the images 102 and 104 above each other in a vertical dimension and placing them next to each other in a horizontal dimension. Sampling lenses 60 and 70 can also move in cooperation with corresponding apertures 82 and 84.

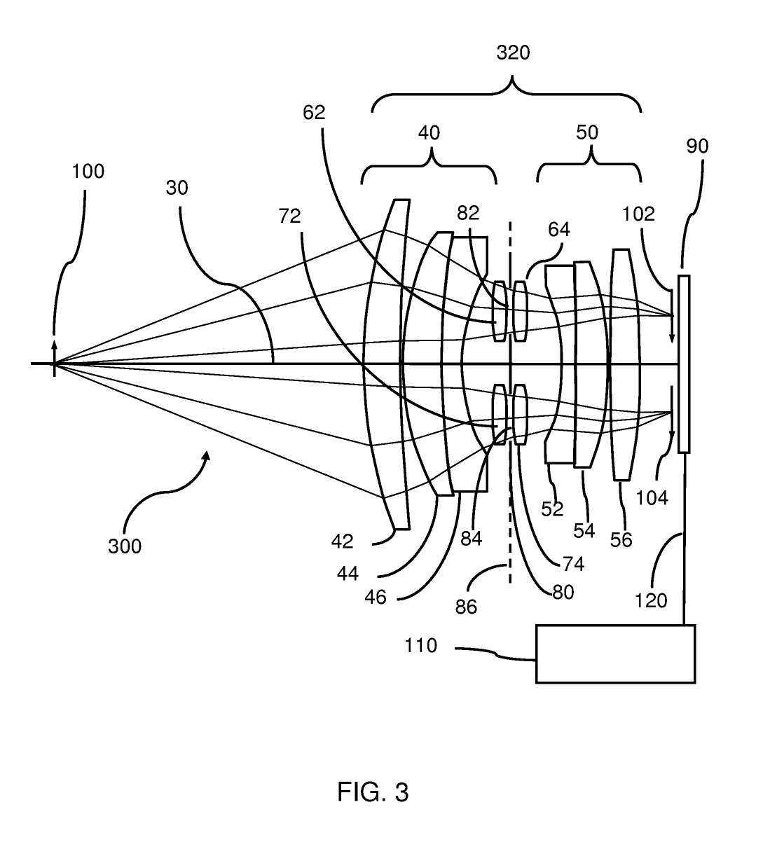

Another embodiment of the stereoscopic imaging apparatus of the present invention is shown generally at 300 in FIG. 3. For the sake of clarity, elements equivalent to those in FIG. 1 bear the same numbers as in FIG. 1, and only additional or different elements have numbers not occurring in FIG. 1. In this embodiment the first sampling lens 60 of FIG. 1 is replaced by a first front component sampling lens 62 and a first rear component sampling lens 64, the first front component sampling lens 62 being disposed between the first aperture 82 and the front lens assembly 40 and proximate the first aperture 82, the first rear component sampling lens 64 being disposed between the first aperture 82 and the rear lens assembly 50 and proximate the first aperture 82. The second sampling lens 70 of FIG. 1 is replaced by a second front component sampling lens 72 and a second rear component sampling lens 74, the second front component sampling lens 72 being disposed between the second aperture 84 and the front lens assembly 40 and proximate the second aperture 84, and the second rear component sampling lens 74 being disposed between the second aperture 84 and the rear lens assembly 50 and proximate the second aperture 84. The fully symmetric double Gauss lens arrangement of the resulting compound lens 320 shown in FIG. 3 leads to improved performance as regards optical aberration.

Again it should be noted that FIG. 3 is schematic. In particular, the paths of light rays through sampling lenses 62, 64, 72 and 74 are purely schematic, the refraction of the light through the four lenses being considerably different from that shown herein. The operation of the imager 300 and lens 320 remain the same as in the embodiment described at the hand of FIG. 1.

In some embodiments of the invention the first front component sampling lens 62 and the first rear component sampling lens 64 together can be a double Gauss lens and the second front component sampling lens 72 and the second rear component sampling lens 74 together can be another double Gauss lens.

It is to be noted that neither the stereoscopic imaging apparatus 10 of the present invention, as shown in FIG. 1, nor apparatus 300, as shown in FIG. 3, creates a real image of the object 100 between the first or the second sampling lens 60 or 70 and any immediately subsequent lens. This reduces the complexity of the sampling lens arrangement as compared with a system that forms an image after the sampling lenses and then relays it.

The stereoscopic imaging apparatus 10 and 300 sample light from the first and second portions of the optical path simultaneously and, unlike many prior art single channel stereoscopic imaging devices, can simultaneously create the first and second images 102 and 104 on imaging sensor 90. The stereoscopic imaging apparatus also holds the benefit of not requiring any polarization of the light from the object in order to operate. This implies that light levels are more than doubled in comparison with polarization based systems. The double Gauss arrangement of lenses 20 and 320 provides a high speed lens system with excellent aberration performance over a large area of imaging sensor 90.

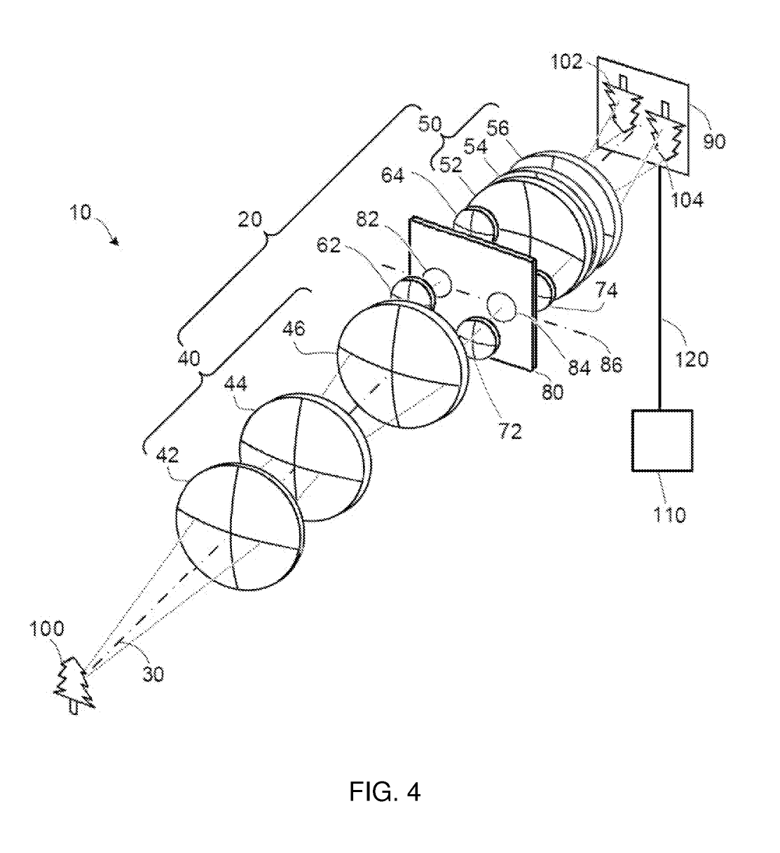

A further embodiment is shown in FIG. 4, which presents a partially exploded view of the apparatus 300 of FIG. 3. In this embodiment the first rear component sampling lens 64 is disposed proximate, overlapping and abaxial with the first aperture 82. The second rear component sampling lens 74 is disposed proximate, overlapping and abaxial with the second aperture 84. By moving the rear component sampling lenses 64 and 74 abaxially with their respective corresponding apertures 82 and 84, images 102 and 104 can be positioned with freedom on imaging sensor 90. This can include placing the images 102 and 104 above each other in a vertical dimension and placing them next to each other in a horizontal dimension. In this embodiment the first front component sampling lens 62 can be disposed proximate, overlapping and abaxial with the first aperture 82. Similarly, second front component sampling lens 72 can be disposed proximate, overlapping and abaxial with the second aperture 84. The extent of abaxial placement of first front component sampling lens 62 relative to first aperture 82 is not in general the same as the extent of abaxial placement of first rear component sampling lens 64. Similarly the extent of abaxial placement of the second front component sampling lens 72 relative to second aperture 84 is not in general the same as the extent of abaxial placement of second rear component sampling lens 74. Sampling lenses 62, 64, 72 and 74 can move in cooperation with corresponding apertures 82 and 84.

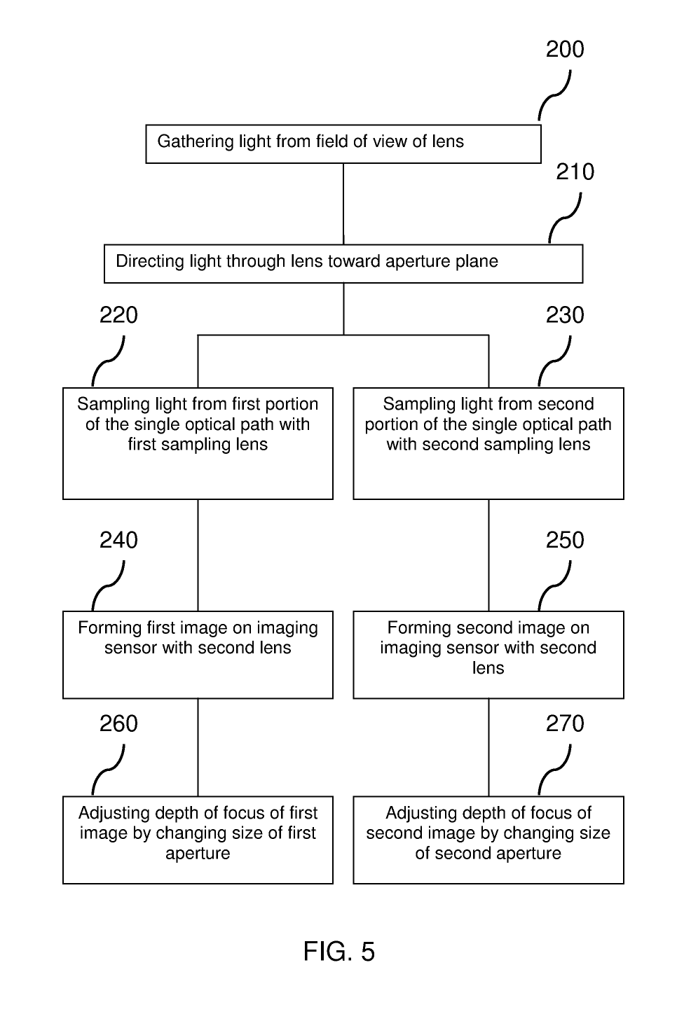

FIG. 5 is a flow chart of a method for forming on the imaging sensor 90 of FIG. 1 and FIG. 2 a stereoscopic image pair, the image pair comprising the first image 102 and the second image 104 providing two different perspectives of the object 100 within the field of view of a first lens, being the front lens assembly 40 of FIG. 1 and FIG. 2, disposed along the optical axis 3. The method comprises gathering [200] light from the object 100 through the front lens assembly 40; directing [210] the gathered light along a single optical path generally about the optical axis 30 to first sampling lens 60 and second sampling lens 70; sampling [220] through first sampling lens 60 disposed proximate the aperture plane 86 light from a first portion of the single optical path, the first sampling lens 60 disposed on a first side of the optical axis 30; simultaneously sampling [230] through the second sampling lens 70 disposed proximate the aperture plane 86 light from a second portion of the single optical path, the second sampling lens 70 disposed on an opposite side of the optical axis 30 from the first sampling lens 60; and on the imaging sensor 90 disposed along the optical axis first and second images 102 and 104 from respectively the light sampled from the first portion of the single imaging path and the light sampled from the second portion of the imaging path. The forming [240] the first image 102 can be by processing the light sampled from the first portion of the single optical path through a second lens, being the rear lens assembly 50 of FIG. 1 and FIG. 2, disposed on the optical axis; and the forming [250] the second image 104 can be by processing the light sampled from the second portion of the single optical path through the second lens.

The method can further comprise at least one of adjusting a depth of focus of the first image 102 by changing [260] the size of the first aperture 82 disposed in the aperture plane 86; and adjusting a depth of focus of the second image 104 by changing [270] the size of the second aperture 84 disposed in the aperture plane 86. The same method of use can be applied to the stereoscopic imager of FIGS. 3 and FIG. 4 in which the sampling lenses are compound lenses arranged in front of and behind suitable apertures, as described herein at the hand of FIG. 3 and FIG. 4.

The imaging sensor 90 can comprise a first and a second component imaging sensor and the method can comprise forming the first 102 and second 104 images on the first and second component imaging sensors respectively.

### NOTES

The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

As used in this disclosure, except where the context requires otherwise, the term “comprise” and variations of the term, such as “comprising,” “comprises” and “comprised” are not intended to exclude other additives, components, integers or steps.

Also, it is noted that the embodiments are disclosed as a process that is depicted as a flowchart, a flow diagram, a structure diagram, or a block diagram. Although a flowchart may disclose various steps of the operations as a sequential process, many of the operations can be performed in parallel or concurrently. The steps shown are not intended to be limiting nor are they intended to indicate that each step depicted is essential to the method, but instead are exemplary steps only.

In the foregoing specification, the invention has been described with reference to specific embodiments thereof. It will, however, be evident that various modifications and changes may be made thereto without departing from the broader spirit and scope of the invention. The specification and drawing are, accordingly, to be regarded in an illustrative rather than a restrictive sense. It should be appreciated that the present invention should not be construed as limited by such embodiments.

From the foregoing description it will be apparent that the present invention has a number of advantages, some of which have been described herein, and others of which are inherent in the embodiments of the invention described or claimed herein. Also, it will be understood that modifications can be made to the device, apparatus and method described herein without departing from the teachings of subject matter described herein. As such, the invention is not to be limited to the described embodiments except as required by the appended claims.

### PARTS LIST

10. Single axis stereoscopic imaging system
20. Lens
30. Optical axis
40. Front lens assembly
50. Rear lens assembly
60. First sampling lens
62. First front component sampling lens
64. First rear component sampling lens
70. Second sampling lens
72. Second front component sampling lens
74. Second rear component sampling lens
80. Aperture plate
82. First aperture
84. Second aperture
86. Aperture plane
90. Imaging sensor
100. Object
102. First image
104. Second image
110. Controller
120. Image data output connection
200. Gathering light from the field of view of lens
210. Directing light through lens toward aperture plane
220. Sampling light from first portion of the single optical path with first sampling lens
230. Sampling light from second portion of the single optical path with second sampling lens
240. Forming first image on imaging sensor with second lens
250. Forming second image on imaging sensor with second lens
260. Adjusting depth of focus of first image by changing size of first aperture
270. Adjusting depth of focus of second image by changing size of second aperture
300. Single axis stereoscopic imaging system
320. Lens

1-44. (canceled)

45. A stereoscopic imager comprising a lens and an imaging sensor disposed behind the lens along an optical axis of the lens, the lens comprising:
a front lens assembly disposed along the optical axis and a rear lens assembly disposed along the optical axis;
first and second sampling lenses disposed on opposite sides of the optical axis between the front lens assembly and the rear lens assembly, and proximate an aperture plane of the lens; the imager further comprising
a first aperture and a second aperture, the first aperture and the second aperture being disposed within the aperture plane of the lens and separated by an inter-aperture distance,
wherein the first and second apertures are configured to allow changing a stereopsis of the imager by changing the inter-aperture distance.

46. The stereoscopic imager of claim 45, said rear lens assembly being disposed between the sampling lenses and the sensor and configured to form on the sensor a first image from light collected by the first sampling lens and a second image from light collected by the second sampling lens.

47. The stereoscopic imager of claim 45, wherein the front lens assembly is configured to provide from a first portion of a field of view of the front lens assembly the light collected by the first sampling lens and to provide from a second portion of the field of view the light collected by the second sampling lens.

48. The stereoscopic imager of claim 45, wherein the first and second sampling lenses are disposed proximate, overlapping and abaxial with the first and second apertures.

49. The stereoscopic imager of claim 48, wherein the lens is configured to allow the first and the second sampling lens to move in cooperation with respectively the first and the second aperture.

50. The stereoscopic imager of claim 48, wherein the first and second apertures are variable apertures.

51. The stereoscopic imager of claim 48, wherein the first sampling lens comprises a first front component sampling lens and a first rear component sampling lens, the first front component sampling lens disposed between the first aperture and the front lens assembly and proximate the first aperture, the first rear component sampling lens disposed between the first aperture and the rear lens assembly and proximate the first aperture; and
the second sampling lens comprises a second front component sampling lens and a second rear component sampling lens, the second front component sampling lens disposed between the second aperture and the front lens assembly and proximate the second aperture, the second rear component sampling lens disposed between the second aperture and the rear lens assembly and proximate the second aperture.

52. The stereoscopic imager of claim 45, wherein the first and second sampling lenses are disposed proximate and substantially in line with the first and second apertures.

53. The stereoscopic imager of claim 52, wherein the lens is configured to allow the first and the second sampling lens to move in cooperation with respectively the first and the second aperture.

54. The stereoscopic imager of claim 52, wherein the first and second apertures are variable apertures.

55. The stereoscopic imager of claim 52, wherein the first sampling lens comprises a first front component sampling lens and a first rear component sampling lens, the first front component sampling lens disposed between the first aperture and the front lens assembly and proximate the first aperture, the first rear component sampling lens disposed between the first aperture and the rear lens assembly and proximate the first aperture; and
the second sampling lens comprises a second front component sampling lens and a second rear component sampling lens, the second front component sampling lens disposed between the second aperture and the front lens assembly and proximate the second aperture, the second rear component sampling lens disposed between the second aperture and the rear lens assembly and proximate the second aperture.

56. The stereoscopic imager of claim 45, wherein the first and second apertures are variable apertures.

57. The stereoscopic imager of claim 45, wherein the first sampling lens comprises a first front component sampling lens and a first rear component sampling lens, the first front component sampling lens disposed between the first aperture and the front lens assembly and proximate the first aperture, the first rear component sampling lens disposed between the first aperture and the rear lens assembly and proximate the first aperture; and
the second sampling lens comprises a second front component sampling lens and a second rear component sampling lens, the second front component sampling lens disposed between the second aperture and the front lens assembly and proximate the second aperture, the second rear component sampling lens disposed between the second aperture and the rear lens assembly and proximate the second aperture.

58. The stereoscopic imager of claim 46, further comprising a controller for extracting image data for the first image and the second image from the sensor, the first image data representing a first perspective of an object in the field of view of the front lens assembly and the second image data representing a second perspective of the object.

59. The stereoscopic imager of claim 45, wherein the focal length of at least one of the first sampling lens and the second sampling lens is less than half the focal length of the combination of the front lens assembly and the rear lens assembly in the absence of the first and second sampling lenses.

60. The stereoscopic imager of claim 45, wherein the focal length of the combination of the front lens assembly, the rear lens assembly and one of the first and second sampling lenses is less than the focal length of the combination of the front lens assembly and the rear lens assembly in the absence of the first and second sampling lenses.

61. The stereoscopic imager of claim 45, wherein the front lens assembly and rear lens assembly together form a double Gauss lens.

62. The stereoscopic imager of claim 45, wherein the front lens assembly and rear lens assembly together are a zoom lens.

63. The stereoscopic imager of claim 46, wherein the sensor comprises a first component sensor disposed to receive the first image and a second component sensor disposed to receive the second image.

64. A method for forming on a sensor a stereoscopic image pair comprising a first image and a second image providing two different perspectives of an object within a field of view of a first lens disposed along an optical axis, the method comprising:
gathering light from the object through the first lens; directing the gathered light along a single optical path generally about the optical axis to a first sampling lens disposed on a first side of the optical axis and to a second sampling lens disposed on an opposite side of the optical axis from the first sampling lens;
sampling through the first sampling lens light from a first portion of the single optical path; simultaneously sampling through a second sampling lens light from a second portion of the single optical path; and
forming on an imaging sensor disposed along the optical axis first and second images from respectively the light sampled from the first portion of the single imaging path and the light sampled from the second portion of the imaging path, and further comprising
changing a stereopsis of the stereoscopic image pair by changing an inter-aperture distance between a first aperture disposed proximate the first sampling lens and a second aperture disposed proximate the second sampling lens.

65. The method of claim 64, wherein the stereopsis is changed by further moving the first sampling lens and the second sampling lens in cooperation with respectively the first aperture and the second aperture.
